(19) United States
(12) Patent Application Publication
(10) Pub. No.: US 2008/0238949 A1
(43) Pub. Date: Oct. 2, 2008

(54) ELECTRONIC DEVICE, IMAGE DISPLAYING METHOD AND IMAGE DISPLAYING PROGRAM STORAGE MEDIUM

(76) Inventor: Hiroshi SHIMAYA, Saitama-Ken (JP)

Correspondence Address: BIRCH STEWART KOLASCH & BIRCH, PO BOX 747, FALLS CHURCH, VA, 22040-0747, US

(21) Appl. No.: 12/049,540

(22) Filed: Mar. 17, 2008

(30) Foreign Application Priority Data
Mar. 26, 2007 (JP) 2007-080144

(51) Int. Cl. G09G 5/00

(52) U.S. Cl. 345/684

(57) ABSTRACT

An electronic device including a display section, a control section, a detection section, a storage section, an acquiring section and a setting section is provided. The control section controls images corresponding to plural predetermined scenes to be displayed on the display section in predetermined order. The detection section detects an instruction input to the electronic device by a user. The storage section stores the images of the scenes, and stores setting information corresponding to the scenes in association with the scenes. The acquisition section acquires, from the storage section, setting information corresponding to the scene displayed when the instruction input from the user is detected while display of the images corresponding to the plural scenes being effected. The setting section sets the acquired setting information in the electronic device.

### CROSS-REFERENCE TO RELATED APPLICATION

This application claims priority under 35 USC 119 from Japanese Patent Application No. 2007-080144, the disclosure of which is incorporated by reference herein.

### BACKGROUND OF THE INVENTION

1. Field of the Invention

The present invention relates to an electronic device, an image displaying method and a storage medium storing an image displaying program. In particular, the invention relates to an electronic device having a function of displaying images corresponding to plural predetermined scenes in predetermined order, an image displaying method and an image displaying program storage medium.

2. Description of the Related Art

A conventional electronic device (equipment) generally has a demonstration function of representing the characteristics of the electronic equipment.

In relation to such demonstration, Japanese Patent Application Laid-open (JP-A) No. 2001-352479 discloses a technique for setting a special operating condition suitable for a demonstration. Furthermore, JP-A No. 11-215416 discloses a technique that a demonstration may be controlled by a user. Moreover, JP-A No. 8-298615 discloses a technique of interrupting a demonstration so as to set a normal image capturing mode or restarting the demonstration.

However, the technique disclosed in JP-A No. 2001-352479 merely enables the setting of the operating condition dedicated to a demonstration mode suitable for a camera operation for the demonstration in a shop, and may not satisfactorily showcase (present) a performance of a function provided by the electronic equipment by the demonstration.

The technique disclosed in JP-A No. 11-215416 may allow forward movement of, reversing of or pausing of the contents of a demonstration mode, but may not satisfactorily showcase a performance provided by the electronic equipment by the demonstration.

Further, the technique disclosed in JP-A No. 8-298615 may allow the setting of the normal image capturing mode during the demonstration, but may not satisfactorily showcase a performance provided by the electronic equipment by the demonstration.

As described above, in the conventional technique, a performance provided by the electronic equipment is not satisfactorily showcased by the demonstration.

### SUMMARY OF THE INVENTION

The present invention provides an electronic device (equipment) capable of satisfactorily showcasing performances of functions provided therein by a demonstration, an image displaying method and a storage medium storing an image displaying program used in such electronic equipment.

According to a first aspect of the invention, an electronic device includes: a display section which displays an image; a control section which controls images corresponding to a plurality of predetermined scenes to be displayed on the display section in a predetermined order; a detection section which detects an instruction input to the electronic device by a user; a storage section which stores the images of the scenes, and stores setting information for the electronic device corresponding to each of the scenes in association with the scenes; an acquisition section which acquires, from the storage section, setting information corresponding to a scene displayed when the instruction input from the user is detected by the detection section while display of the images corresponding to the plurality of scenes is being effected by the control section; and a setting section which sets the setting information acquired by the acquisition section in the electronic device.

With the configuration according to the first aspect, the performance of the function provided by the electronic equipment may be satisfactorily showcased by the demonstration.

In the first aspect, a plurality of detection sections may be provided; and the acquisition section may acquire, from the storage section, the setting information corresponding to the scene displayed only when the instruction input from the user is detected by a specified detection section among the plurality of detection sections.

With this configuration, it is possible to avoid any acquisition of the setting information due to an erroneous operation by a user.

In the first aspect, the specified detection section may be different depending upon the scene.

With this configuration, it is possible to avoid any acquisition of the setting information due to an erroneous operation by a user.

In the first aspect, setting screen data describing a setting screen, which corresponds to each of the scenes and is displayed at the display section when the user performs a setting with respect to the electronic device, may be further stored in the storage section in association with each of the scenes; and the acquisition section may acquire, from the storage section, the setting screen data when the instruction input from the user is detected by the detection section while display of the images corresponding to the plurality of scenes is being effected by the control section, and display the setting screen described by the acquired setting screen data at the display section.

With this configuration, a user may confirm an actual setting screen.

In the first aspect, the control section may effect control so as to interrupt the display at the display section when the instruction input from the user is detected by the detection section; and after the setting section sets the setting information, the control section may effect control so as to display, at the display section, a screen displaying content that inquires of the user as to whether or not to restart the display at the display section.

With this configuration, the user may repeatedly experience operations since an inquiry is made to the user about whether or not the display on the display section is restarted after the operation by the user.

Further, in the first aspect, the electronic equipment may be a digital camera.

A second aspect of the invention is an image displaying method in an electronic device including a display section for displaying an image and a storage section, the image displaying method including: controlling images corresponding to a plurality of predetermined scenes to be displayed in a predetermined order at the display section; detecting an instruction input to the electronic device by a user; when the instruction input from the user is detected during display of the images corresponding to the plurality of scenes, acquiring setting information corresponding to a scene displayed at that time from the storage section that stores the images of the scenes and stores the setting information for the electronic device corresponding to each of the scenes in association with the scenes; and setting the acquired setting information in the electronic device.

A third aspect of the invention is a storage medium storing a program that causes an electronic device including a display section for displaying images and a storage section to execute an image display processing, the image display processing comprising: controlling images corresponding to a plurality of predetermined scenes to be displayed in a predetermined order at the display section; detecting an instruction input to the electronic device by a user; when the instruction input from the user is detected during display of the images corresponding to the plurality of scenes, acquiring setting information corresponding to a scene displayed at that time from the storage section that stores the images of the scenes and stores the setting information for the electronic device corresponding to each of the scenes in association with the screens; and setting the acquired setting information in the electronic device.

Since the second and third aspects act in the same manner as the first aspect, they produce the same effects as those produced by the first aspect.

### BRIEF DESCRIPTION OF THE DRAWINGS

Exemplary embodiments of the present invention will be described in detail based on the following figures, wherein:

FIG. 1 is a diagram illustrating a configuration of an appearance of a digital camera according to an exemplary embodiment;

FIG. 2 is a diagram illustrating an electric system of the digital camera of the exemplary embodiment;

FIG. 3 is a table illustrating a demonstration database;

FIG. 4 is a flowchart illustrating a demonstration control processing of a first exemplary embodiment;

FIG. 5 is a diagram illustrating an example demonstration screen (high sensitive image capture);

FIG. 6 is a diagram illustrating another example demonstration screen (guide display);

FIG. 7 is a flowchart illustrating a demonstration control processing of a second exemplary embodiment;

FIG. 8 is a flowchart illustrating a demonstration control processing of a third exemplary embodiment;

FIG. 9 is a diagram illustrating a setting screen;

FIG. 10 is a flowchart illustrating a demonstration control processing of a fourth exemplary embodiment;

FIG. 11 is a diagram illustrating a further example demonstration screen (slideshow);

FIG. 12 is a diagram illustrating a restart inquiry screen; and

FIG. 13 is a flowchart illustrating a demonstration control processing of a fifth exemplary embodiment.

### DETAILED DESCRIPTION OF THE INVENTION

Exemplary embodiments according to the present invention will be described in detail below in reference to the accompanying drawings. Here, explanation will be made on an electronic equipment exemplified by a digital camera in the exemplary embodiments.

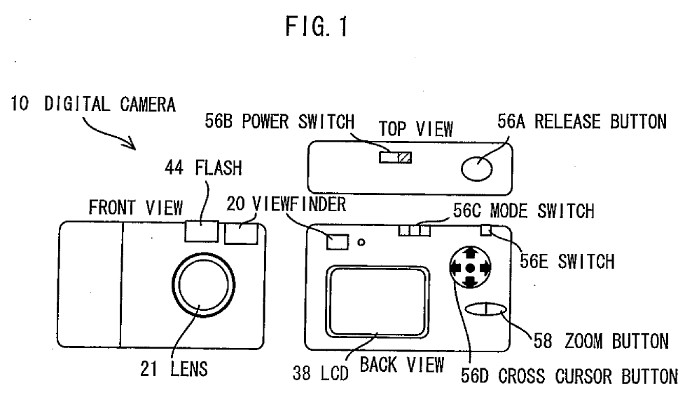

A configuration of an appearance of a digital camera 10 according to the exemplary embodiment will be described with reference to FIG. 1. A lens 21, a viewfinder 20 and a flash 44 are provided at a front face of the digital camera 10. The lens 21 is an optical member for focusing an image of an object of photographing. The viewfinder 20 is used for determining the composition of the object to be captured. A release button (the “shutter”) 56A, and a power switch 56B are provided at an upper face of the digital camera 10. The release button 56A is pressed for operation when image capture is to be executed.

The release button 56A of the digital camera 10 relating to the present embodiment is structured to be capable of sensing a two-stage pressing operation: a state which is pressed down to an intermediate position (hereinafter referred to as a half-pressed state) and a state which is pressed beyond the intermediate position to a lowermost position (hereinafter referred to as a full-pressed state).

In the digital camera 10, when the release button 56A is half-pressed, lightness of a subject is measured, and based on the measurement result, an AE (automatic exposure) function operates and exposure conditions (shutter speed and aperture) are specified. Thereafter, an AF (auto focus) function operates to regulate focusing, and exposure (image capture) is performed when the release button 56A is further pressed to the full-pressed state.

At a back face of the digital camera 10, an eyepiece of the above-described viewfinder 20; the LCD 38, a mode switch 56C and a zoom button 58 are provided. The LCD 38 displays a captured image of a subject, a menu screen and the like. The mode switch 56C can be slidably operated for setting either one of an image capturing mode for capturing an image, and a reproducing mode for reproducing and displaying the captured image of the subject on the LCD 38. The zoom button 58 is for magnifying or reducing the image of a subject.

Furthermore, a cross cursor button 56D and a switch 56E are disposed at the back face of the digital camera 10. The switch 56E is adapted to switch functions of automation, red-eye minimization, light emission prohibition, forcible light emission, slow synchronization and the like.

Incidentally, the cross cursor button 56D includes four arrow keys indicating four movement directions, that is, up, down, right and left in a display region on the LCD 38, and an execution key located at the center of the arrow keys.

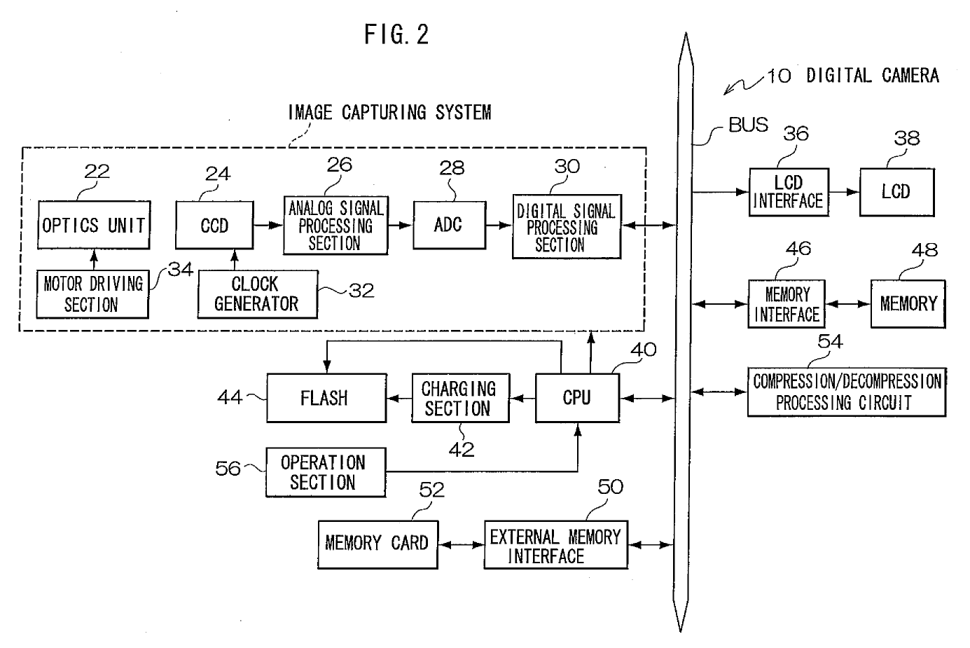

Next, a description of the electric arrangement of the digital camera 10 in the present exemplary embodiment will be given below in reference to FIG. 2.

The digital camera 10 is structured to include an optics unit 22, a charge coupled device hereinafter referred to as “CCD”) 24 and an analog signal processing section 26. The optics unit 22 is structured to include the aforementioned lens 21. The CCD 24 is disposed on an optical axis of the lens 21 at a rear side thereof. The analog signal processing section 26 performs various kinds of analog signal-processing on analog signals inputted thereto.

The digital camera 10 is further structured to include an analog/digital converter (hereinafter referred to as “ADC”) 28 and a digital signal processing section 30. The ADC 28 converts analog signals inputted thereto to digital data. The digital signal processing section 30 performs various kinds of digital signal-processing on digital data inputted thereto.

The digital signal processing section 30 incorporates a line buffer with a predetermined capacity, and performs control so as to directly store the inputted digital data at a predetermined region of a memory 48, which will be discussed later.

An output terminal of the CCD 24 is connected to an input terminal of the analog signal processing section 26, an output terminal of the analog signal processing section 26 is connected to an input terminal of the ADC 28, and an output terminal of the ADC 28 is connected to an input terminal of the digital signal processing section 30. Accordingly, an analog signal representing a subject image, which is outputted from the CCD 24, is subjected to a predetermined analog signal-processing by the analog signal processing section 26, converted to digital image data by the ADC 28, and then inputted to the digital signal processing section 30.

The digital camera 10 is further structured to include an LCD interface 36, a CPU (central processing unit) 40, the memory 48 (a memory device) and a memory interface 46. The LCD interface 36 generates signals for display of subject images, menu screens and the like at the LCD 38, and supplies the signals to the LCD 38. The CPU 40 administers overall operations of the digital camera 10. The memory 48 stores digital image date obtained by image captures and the like. The memory interface 46 implements access control to the memory 48.

The digital camera 10 also includes an external memory interface 50, and a compression/decompression processing circuit 54. The external memory interface 50 is for enabling access from the digital camera 10 to a portable memory card 52. The compression/decompression processing circuit 54 performs compression processing and decompression processing on the digital image data.

In the digital camera 10 of the present embodiment, at least one of a VRAM (Video RAM), SRAM, DRAM, and a flash memory is employed as the memory 48 and a SMART MEDIA® is employed as the memory card 52.

The digital signal processing section 30, the LCD interface 36, the CPU 40, the memory interface 46, the external memory interface 50, and the compression/decompression processing circuit 54 are connected to one another via a system bus BUS. Thus, the CPU 40 can perform control of operations of the digital signal processing section 30 and the compression/decompression processing circuit 54, display various kinds of information on the LCD 38 via the LCD interface 36, and implement access to the memory 48 and the memory card 52 via the memory interface 46 and the external memory interface 50.

The digital camera 10 is further provided with a clock generator 32 which generates timing signals, principally for driving the CCD 24, and supplies the timing signals to the CCD 24. Driving of the CCD 24 is controlled by the CPU 40 via the clock generator 32.

Further still, a motor driving section 34 is provided in the digital camera 10. Driving of an unillustrated focal point adjustment motor, zoom motor and aperture-driving motor, which are provided at the optics unit 22, is controlled by the CPU 40 via the motor driving section 34.

The lens 21 relating to the present embodiment includes a number of lenses, and is structured as a zoom lens which is capable of altering a focusing distance (magnification). The lens 21 is equipped with an unillustrated lens-driving mechanism. This lens-driving mechanism includes the above-mentioned focal point adjustment motor, zoom motor and aperture-driving motor. These motors are respectively driven by driving signals supplied from the motor driving section 34 in accordance with control by the CPU 40.

The aforementioned release button 56A, power switch 56B, mode switch 56C, cross cursor button 56D, zoom button 58, and switch 56E (which are shown all together as an operation section 56 in FIG. 2) are connected to the CPU 40. The CPU 40 can constantly acquire operation states of the operation section 56.

The digital camera 10 is further equipped with a charging section 42. The charging section 42 is interposed between the flash 44 and the CPU 40, and supplies electrical power for emitting light from the flash 44, in accordance with control by the CPU 40. The flash 44 is also connected to the CPU 40, and light emission from the flash 44 is controlled by the CPU 40.

Next, overall operations of the digital camera 10 relating to the present embodiment at a time of image capture will be briefly described.

First, the CCD 24 performs imaging through the optics unit 22, and sequentially outputs analog signals representing the subject image, of each of R (red), G (green), and B (blue), to the analog signal processing section 26. The analog signal processing section 26 performs analog signal-processing, such as correlated double sampling processing and the like, on the analog signals inputted from the CCD 24, and then sequentially outputs analog signals to the ADC 28.

The ADC 28 converts the respective R, G and B analog signals inputted from the analog signal processing section 26 to respective 12-bit R, G and B signals (i.e., digital image data), and sequentially outputs these signals to the digital signal processing section 30. The digital signal processing section 30 accumulates the digital image data that is sequentially inputted from the ADC 28 at the incorporated line buffer, and temporarily stores the digital image data directly to a predetermined region of the memory 48.

The digital image data that has been stored at the predetermined region of the memory 48 is read out by the digital signal processing section 30 in response to control by the CPU 40. The digital signal processing section 30 implements white balance control by the application of digital gain in accordance with predetermined physical quantities, performs gamma processing and sharpness processing, and generates predetermined-bit, for example, 8-bit digital image data.

Then, the digital signal processing section 30 performs YC signal processing on the generated predetermined-bit digital image data, to generate brightness signals Y and chroma signals Cr and Cb (hereinafter referred to as “YC signals”), and stores the YC signals at a region of the memory 48 other than the above-mentioned predetermined region.

Herein, the LCD 38 is structured as a display which displays a moving image (a through-image) obtained by continuous imaging by the CCD 24, and can be used as a viewfinder. When the LCD 38 is used as a viewfinder, the generated YC signals are sequentially outputted via the LCD interface 36 to the LCD 38. Thus, the LCD 38 displays the through-image.

Now, if the release button 56A is half-pressed by a user, the AE function operates to set exposure conditions as mentioned earlier. Then, the AE function operates to control focusing. Thereafter, at a time at which the release button 56A continues to the full-pressed state, the YC signals that are stored in the memory 48 at that point in time are compressed in a predetermined compression format (in the present embodiment, JPEG) by the compression/decompression processing circuit 54 and are stored, via the external memory interface 50, as an electronic file at the memory card 52.

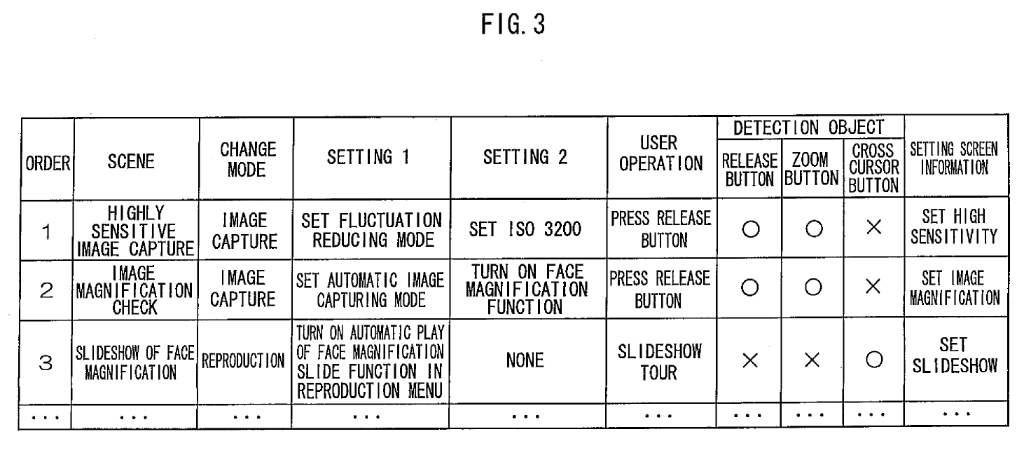

Next, a demonstration database (hereinafter referred to as “a demo DB”) will be described below in reference to FIG. 3. The demo DB includes data structures of “Order”, “Scene”, “Change Mode”, “Setting 1”, “Setting 2”, “User Operation”, “Detection Object” and “Setting Screen Data”, as illustrated in FIG. 3.

“Order” indicates the order of the demonstration. “Scene” indicates the contents of the demonstration. “Change Mode” indicates an operation mode which is changed when an instruction input from a user is detected, as described later. The modes include an image capturing mode and a reproducing mode, as illustrated in FIG. 3. The demonstration per se is executed in the reproducing mode. An image may be actually captured in the image capturing mode.

“Setting 1” and “Setting 2” respectively specify setting information corresponding to each of the scenes. There are one or more pieces of setting information for one scene. Although at most two pieces of setting information are shown in illustrated in FIG. 3, the number is not limited to two.

“User Operation” specifies a user operation as a trigger for restarting an interruption of the demonstration, as described later. “Detection Object” indicates from which of the release button 56A, the cross cursor button 56D and the zoom button 58 an instruction input is to be detected. Incidentally, the release button 56A, the cross cursor button 56D and the zoom button 58 correspond to detection sections.

“Setting Screen Data” is information describing the setting screen displayed on the LCD 38 when a user performs a setting to the digital camera 10, which is also provided for each of the screens.

As described above, the demonstration DB stores the screens (images) of the scenes, and stores plural items of the setting information for the digital camera 10 corresponding to each of the scenes in association with storage of the screens. Moreover, the demonstration DB further stores, in association with each of the scenes, the setting screen data describing the setting screen, which corresponds to the scene and is displayed on the LCD 38 when a user performs setting to the digital camera 10.

Among the release button 56A, the cross cursor button 56D and the zoom button 58, the button indicated by a circle (i.e., “o”) in FIG. 3 serves as a specified detection section. The setting information corresponding to the scene displayed at that time may be acquired only in the case where the instruction input by the user is detected by the specified detection section. As illustrated in FIG. 3, the specified detection section may be different for each of the scenes.

The demo DB is stored in advance in, for example, the aforementioned memory card 52, the memory 48 or the like.

Next, an explanation will be made on a demonstration control processing in the exemplary embodiments in reference to flowcharts. The flowcharts illustrate processings to be executed by the CPU 40.

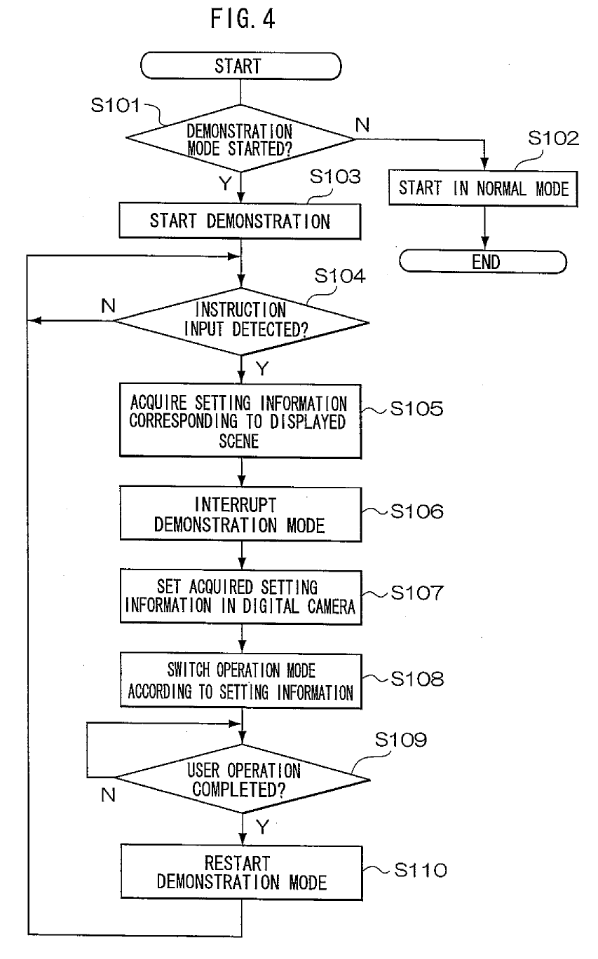

Firstly, a demonstration control processing of a first exemplary embodiment will be explained in reference to a flowchart of FIG. 4. Upon turning-on of a power source, it is determined whether the digital camera 10 is started in a demonstration mode or a normal mode based on an operation at the time of the power-on. Here, the demonstration mode in the present exemplary embodiment is to be executed by a reproduction slideshow.

Therefore, in step 101, it is determined whether or not the digital camera 10 is started in the demonstration mode. If the result is negative, the digital camera 10 is started in the normal mode in step 102, and a control routine relevant to the demonstration control processing is terminated. On the other hand, if the digital camera 10 is started in the demonstration mode, the demonstration is started in step 103. Accordingly, the CPU 40 effects control so as to display images corresponding to plural predetermined scenes stored in the demo DB on the LCD 38 in the predetermined order.

During the execution of the demonstration, the digital camera 10 waits for a detection of the instruction input in step 104. Upon the detection of the instruction input, the setting information corresponding to the displayed scene is acquired from the demo DB in step 105. Thereafter, the demonstration mode is interrupted in step 106, and then, the setting information acquired in step 105 is set in the digital camera 10 in step 107.

The operation mode (see the demo DB) is changed in response to the setting information in step 108. The user may perform the operation in this state, and therefore, the digital camera 10 waits for completion of the user operation in the next step 109. This user operation will correspond to the user operation which is specified for the scene (setting information) as stored in the demo DB. When it is determined that the user operation is completed, the demonstration mode is restarted in step 110, and the control routine returns to the processing in step 104.

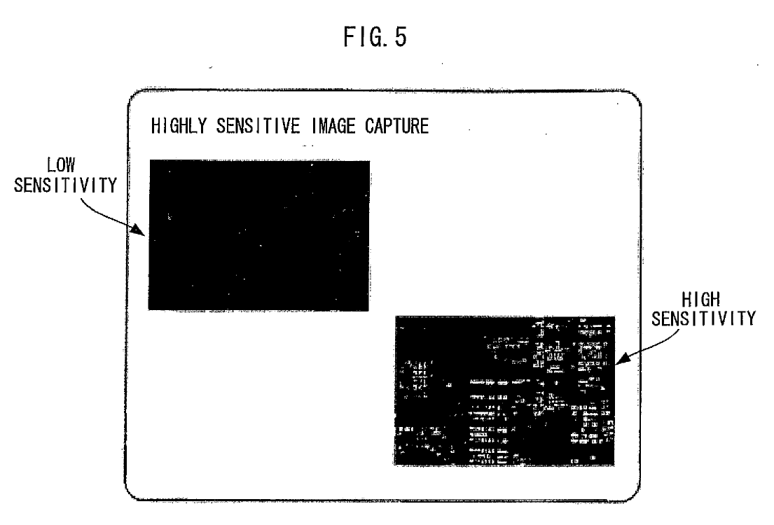

The processing will be explained below by way of an example when the demonstration screen is for a scene of “a highly sensitive image capturing”. In this case, the demonstration screen (i.e., a highly sensitive image capturing scene) shown in FIG. 5 is displayed. An image of a subject captured at a low sensitivity and an image of a subject captured at a high sensitivity are displayed on the demonstration screen.

If the user presses the release button 56A at the time when this demonstration screen is displayed, the operation mode in the digital camera 10 is switched to the image capturing mode, and the digital camera 10 is set in the fluctuation reducing mode and at a sensitivity of ISO 3200. When the user presses the release button 56A in this state, an image is captured with a high sensitivity in this case, and then the demonstration mode is restarted.

In this manner, the user may try a function instantaneously and without any need of a setting operation if the user desires to try the function during the demonstration. Therefore, performances provided with the digital camera 10 may be satisfactorily showcased by the demonstration.

Next, a description will be given for a processing of a second exemplary embodiment that acquires the setting information corresponding to the scene displayed at that time from the demo DB only when the instruction input by the user is detected from the specified detection section.

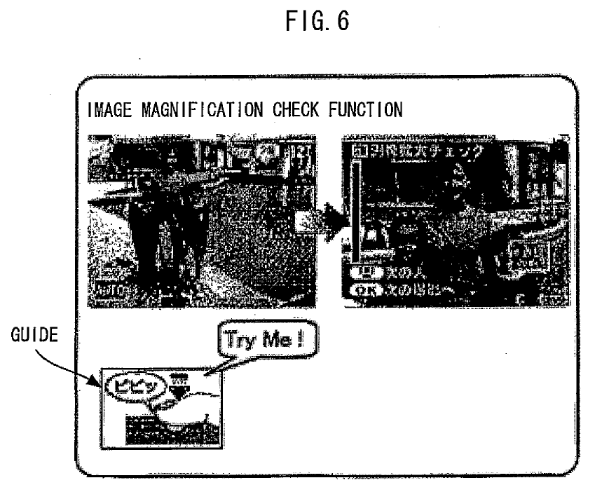

During this demonstration, a guide such as illustrated in FIG. 6 may be displayed on the screen. In FIG. 6, the guide prompts the user to press the release button 56A. In this case, the setting information corresponding to the scene displayed at that time is acquired only when the depression of the release button 56A is detected.

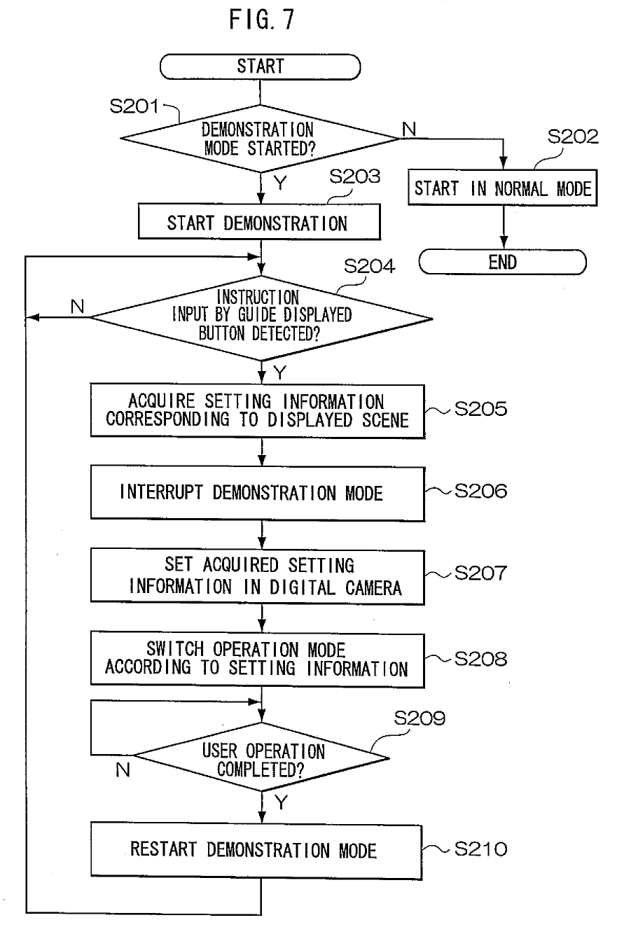

This processing will be explained in reference to a flowchart of FIG. 7. Firstly, it is determined in step 201 whether or not the digital camera 10 is started in the demonstration mode. If the result is negative, the digital camera 10 is started in the normal mode in step 202, and the control routine relevant to the demonstration control processing is terminated. On the other hand, if the digital camera 10 is started in the demonstration mode, the demonstration is started in step 203. Accordingly, the CPU 40 effects control so as to display images corresponding to plural predetermined scenes stored in the demo DB on the LCD 38 in the predetermined order.

During the execution of the demonstration, the digital camera 10 waits for a detection of the instruction input by a button indicated by a guide in step 204. Upon the detection of the instruction input, the setting information corresponding to the displayed scene is acquired from the demo DB in step 205. Thereafter, the demonstration mode is interrupted in step 206, and then, the setting information acquired at step 205 is set in the digital camera 10 in step 207.

The operation mode is switched in accordance to the setting information (see the demo DB) in step 208. The user may perform the operation in this state, and therefore the digital camera 10 waits for completion of the user operation in the next step 209. This user operation will correspond to the user operation which is specified for the scene (setting information) as stored in the demo DB. When it is determined that the user operation is completed, the demonstration mode is restarted in step 210, and the control routine returns to the processing in step 204.

In this manner, the user may try a function instantaneously without any need of a setting operation and in accordance with the displayed guide while avoiding any acquisition of the setting information due to an erroneous operation by the user when the user desires to try the function during the demonstration. Therefore, performances provided with the digital camera 10 may be satisfactorily showcased by the demonstration.

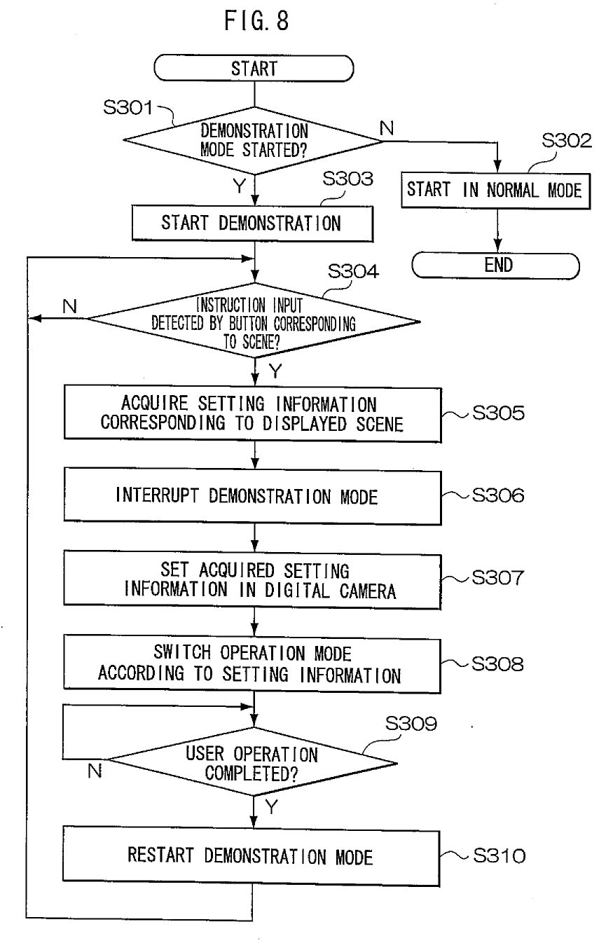

Next, a description will be given of the processing of a third exemplary embodiment in which the specified detection section is different with respect to each of the scene in reference to a flowchart of FIG. 8. Firstly, it is determined in step 301 whether or not the digital camera 10 is started in the demonstration mode. If the result is negative, the digital camera 10 is started in the normal mode in step 302, and the control routine relevant to the demonstration control processing is terminated. On the other hand, if the digital camera 10 is started in the demonstration mode, the demonstration is started in step 303. Accordingly, the CPU 40 effects control so as to display images corresponding to the plural predetermined scenes stored in the demo DB on the LCD 38 in the predetermined order.

During the execution of the demonstration, the digital camera 10 waits for detection of the instruction input by a button corresponding to the displayed scene in step 304. Upon the detection of the instruction input, the setting information corresponding to the displayed scene is acquired from the demo DB in step 305. Here, the button corresponding to the scene is the button specified for the scene in the demo DB, which is indicated by the circle (i.e., “o”) in FIG. 3. For example, when the scene is of the highly sensitive image capturing, the specified button is the release button 56A or the zoom button 58.

The demonstration mode is interrupted in next step 306, and the setting information acquired at step 305 is set in the digital camera 10 in step 307.

The operation mode is switched in response to the setting information (see the demo DB) in step 308. The user may perform an operation in this state, and the digital camera 10 waits for completion of the user operation in the next step 309. This user operation will correspond to the user operations, which is specified for the scene (setting information) as stored in the demo DB. When it is determined that the user operation is completed, the demonstration mode is restarted in step 310, and the control routine returns to the processing in step 304.

In this manner, it is possible to avoid any acquisition of the setting information due to an erroneous operation by the user, to prevent any interruption of the demonstration mode caused by the erroneous operation, and further, to give the user an opportunity to sensibly experience an actual operation without feeling any frustrations. Therefore, performances provided with the digital camera 10 may be satisfactorily showcased by the demonstration.

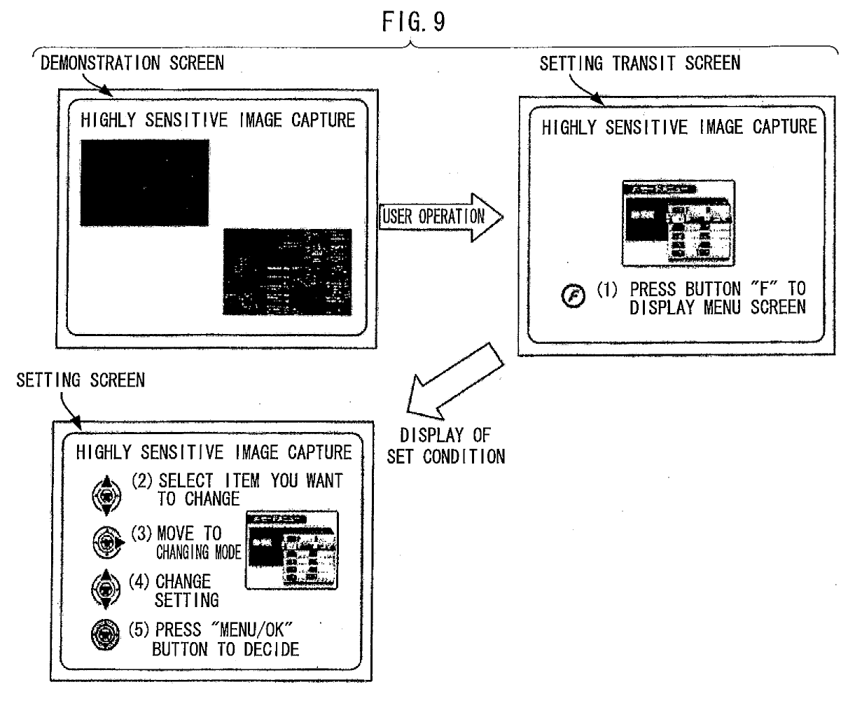

Next, a description will be given of the processing of a fourth exemplary embodiment in which an actual setting screen is displayed on the LCD 38 during the demonstration. Firstly, a setting screen to be displayed on the LCD 38 will be explained in reference to FIG. 9. A demonstration screen, a setting transit screen and a setting screen are illustrated in FIG. 9. As illustrated in FIG. 9, the setting transit screen is displayed due to the operation by the user during the display of the demonstration screen, and thereafter, the setting screen is displayed. The setting information set by the setting screen is set in the digital camera 10.

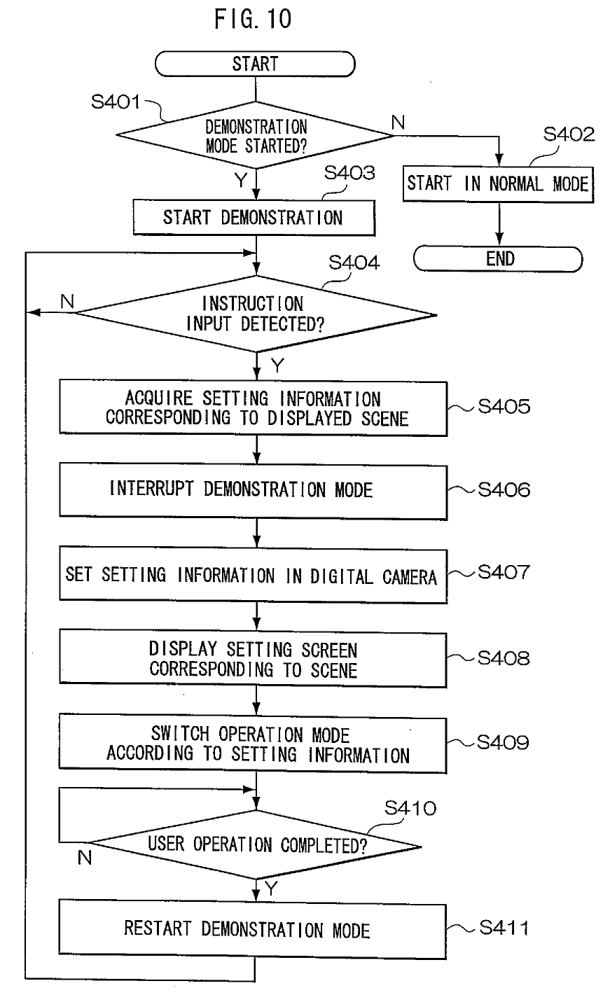

The processing for displaying the setting screen will be explained below in reference to a flowchart of FIG. 10. Firstly, it is determined in step 401 whether or not the digital camera 10 is started in the demonstration mode. If the result is negative, the digital camera 10 is started in the normal mode in step 402, and the control routine relevant to the demonstration control processing is terminated. On the other hand, if the digital camera 10 is started in the demonstration mode, the demonstration is started in step 403. Accordingly, the CPU 40 effects control so as to display images corresponding to the plural predetermined scenes stored in the demo DB on the LCD 38 in the predetermined order.

During the execution of the demonstration, the digital camera 10 waits for the detection of the instruction input in step 404. Upon detection of the instruction input, the setting information corresponding to the displayed scene is acquired from the demo DB in step 405. The demonstration mode is interrupted in next step 406, and the setting information acquired at step 405 is set in the digital camera 10 in step 407. In next step 408 the setting screen corresponding to the setting information as stored in the demo DB is displayed. The setting screen reflects the setting information acquired at step 405. The setting screen herein includes plural screens which are required for the setting, as well as the setting transit screen.

Thereafter, the operation mode is switched in response to the setting information (see the demo DB) in step 409. The user may perform an operation in this state, and the digital camera 10 waits for completion of the user operation in next step 410. This user operation will correspond to the user operations, which is specified for the scene (setting information) as stored in the demo DB. When it is determined that the user operation is completed, the demonstration mode is restarted in step 411, and the control routine returns to the processing in step 404.

In this manner, the user may confirm the actual setting screen during the demonstration, so that performances provided with the digital camera 10 may be satisfactorily showcased by the demonstration.

Next, a description will be given of a processing of a fifth exemplary embodiment in which a screen displaying the content that inquires of the user as to whether or not the demonstration is to be restarted is displayed on the LCD 38 after the setting information is set.

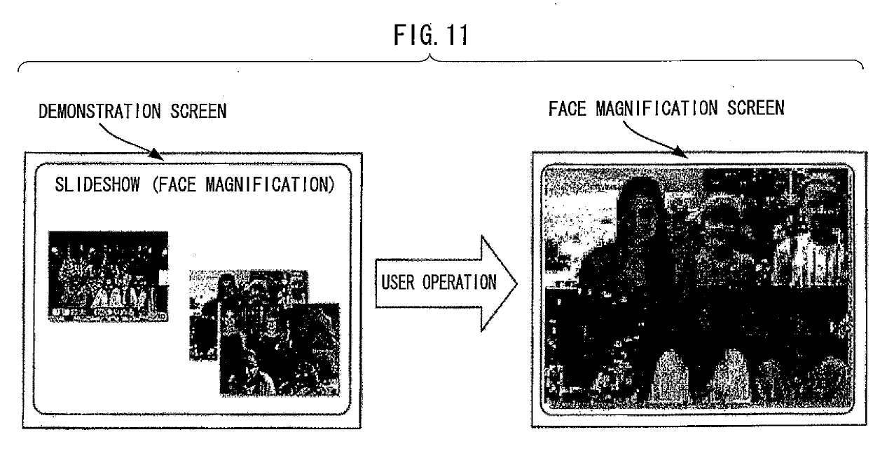

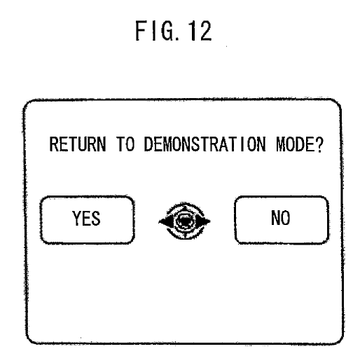

As illustrated in FIG. 11, when the user operates in the state in which the demonstration of, for example, a slideshow scene is displayed, the setting information is set to the digital camera, and a face magnification screen appears, as illustrated in FIG. 11. Thereafter, when a slideshow completes the tour (see the demo DB), a screen having content that inquires of the user as to whether or not the demonstration display is to be restarted is displayed as illustrated in FIG. 12, unlike as in the foregoing exemplary embodiments in which the demonstration is simply restarted. On the screen illustrated in FIG. 12 are displayed messages “return to demonstration mode?”, “Yes” and “No”. Here, if the user selects “Yes”, the demonstration is restarted: in contrast, if the user selects “No”, the demonstration is not restarted and the user may perform the operation relating to the slideshow again.

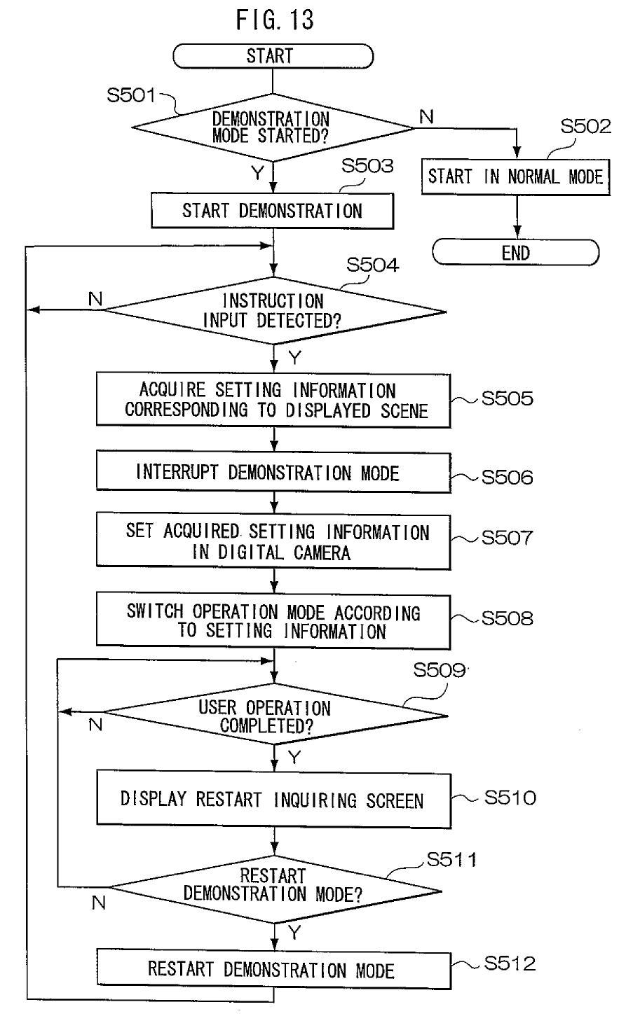

This processing will be explained below in reference to a flowchart illustrated in FIG. 13. Firstly, it is determined in step 501 whether or not the digital camera 10 is started in the demonstration mode. If the result is negative, the digital camera 10 is started in the normal mode in step 502, and the control routine relevant to the demonstration control processing is terminated. On the other hand, if the digital camera 10 is started in the demonstration mode, the demonstration is started in step 503. Accordingly, the CPU 40 effects control so as to display images corresponding to the plural predetermined scenes stored in the demo DB on the LCD 38 in the predetermined order.

During the execution of the demonstration, the digital camera 10 waits for the detection of the instruction input in step 504. Upon the detection of the instruction input, the setting information corresponding to the displayed scene is acquired from the demo DB in step 505. Thereafter, the demonstration mode is interrupted in step 506, and the setting information acquired at step 505 is set in the digital camera 10 in step 507.

The operation mode is switched in response to the setting information (see the demo DB) in step 508. The user may perform an operation in this state, and the digital camera 10 waits for completion of the user operation in next step 509. The user operation will correspond to the user operations, which is specified for the scene (setting information) as stored in the demo DB. When it is determined that the user operation is completed, the restart inquiring screen, as illustrated in FIG. 12, is displayed in step 510.

If it is determined in next step 511 that the user selects to restart the demonstration mode, the demonstration mode is restarted in step 512 and the control routine returns to the processing in step 504. In contrast, if it is determined in step 511 that the user does not select the restart of the demonstration mode, the digital camera 10 waits for the completion of the operation by the user in step 509.

In this manner, the user may sensitively experience the operation many times, so that performances provided with the digital camera 10 may be satisfactorily showcased by the demonstration.

Although the highly sensitive image capture, the image magnification check and the slideshow of face magnification are described as examples of the demonstration scenes in the above-described exemplary embodiments, the demonstration scenes are not limited to these. Further, although the digital camera 10 of the exemplary embodiments waits for the operation by the user in steps 109, 209, 309, 411 and 509, the demonstration may be restarted if no operation is detected within at least a predetermined period or more.

Further, although a digital camera is described as an example of the electronic equipment (device) in the exemplary embodiments, it is not limited to this. The exemplary embodiments are designed to set, in the electronic equipment, the setting information corresponding to the scene displayed at the time when the detection section detects the instruction input by the user during the demonstration. Therefore, the electronic equipment is not limited to the digital camera, and it should be appreciated that the exemplary embodiments may be applied to electronic equipments such as a personal computer, a mobile phone, a PDA, and the like.

The processing illustrated in each of the flowcharts is described simply for a purpose of example. Therefore, it should be appreciated that processing orders may be replaced, new steps may be added, or unnecessary steps may be omitted without departing from the scope of the present invention.

As described above, the invention may provide an electronic equipment (device) in which performances thereof may be satisfactorily showcased by the demonstration, an image displaying method and a storage medium storing an image displaying program, which may used in the electronic equipment.

What is claimed is:

1. An electronic device comprising:
a display section which displays an image;
a control section which controls images corresponding to a plurality of predetermined scenes to be displayed on the display section in a predetermined order;
a detection section which detects an instruction input to the electronic device by a user;
a storage section which stores the images of the scenes, and stores setting information for the electronic device corresponding to each of the scenes in association with the scenes;
an acquisition section which acquires, from the storage section, setting information corresponding to a scene displayed when the instruction input from the user is detected by the detection section while display of the images corresponding to the plurality of scenes is being effected by the control section; and
a setting section which sets the setting information acquired by the acquisition section in the electronic device.

2. The electronic device as claimed in claim 1, wherein:
a plurality of detection sections are provided; and
the acquisition section acquires, from the storage section, the setting information corresponding to the scene displayed only when the instruction input from the user is detected by a specified detection section among the plurality of detection sections.

3. The electronic device as claimed in claim 2, wherein the specified detection section is different depending upon the scene.

4. The electronic device as claimed in claim 1, wherein:
setting screen data describing a setting screen, which corresponds to each of the scenes and is displayed at the display section when the user performs a setting with respect to the electronic device, is further stored in the storage section in association with each of the scenes; and
the acquisition section acquires, from the storage section, the setting screen data when the instruction input from the user is detected by the detection section while display of the images corresponding to the plurality of scenes is being effected by the control section, and displays the setting screen described by the acquired setting screen data at the display section.

5. The electronic device as claimed in claim 1, wherein:
the control section effects control so as to interrupt the display at the display section when the instruction input from the user is detected by the detection section; and
after the setting section sets the setting information, the control section effects control so as to display, at the display section, a screen displaying content that inquires of the user as to whether or not to restart the display at the display section.

6. The electronic device as claimed in claim 1, wherein the electronic device comprises a digital camera.

7. An image displaying method in an electronic device including a display section for displaying an image and a storage section, the image displaying method comprising:
controlling images corresponding to a plurality of predetermined scenes to be displayed in a predetermined order at the display section;
detecting an instruction input to the electronic device by a user;
when the instruction input from the user is detected during display of the images corresponding to the plurality of scenes, acquiring setting information corresponding to a scene displayed at that time from the storage section that stores the images of the scenes and stores the setting information for the electronic device corresponding to each of the scenes in association with the scenes; and
setting the acquired setting information in the electronic device.

8. A storage medium storing a program that causes an electronic device including a display section for displaying images and a storage section to execute an image display processing, the image display processing comprising:
controlling images corresponding to a plurality of predetermined scenes to be displayed in a predetermined order at the display section;
detecting an instruction input to the electronic device by a user;
when the instruction input from the user is detected during display of the images corresponding to the plurality of scenes, acquiring setting information corresponding to a scene displayed at that time from the storage section that stores the images of the scenes and stores the setting information for the electronic device corresponding to each of the scenes in association with the screens; and
setting the acquired setting information in the electronic device.
